(19) United States
(12) Patent Application Publication
(10) Pub. No.: US 2003/0056128 A1
(43) Pub. Date: Mar. 20, 2003

(54) Apparatus and method for a selectable Ron driver impedance

(76) Inventors: Michael W. Leddige, Beaverton, OR (US); James A. McCall, Beaverton, OR (US); Steven M. Stahlberg, Salem, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/957,104

(22) Filed: Sep. 20, 2001

(51) Int. Cl. G06F 1/26

(52) U.S. Cl. 713/300

(57) ABSTRACT

A method and apparatus for a selectable RON driver impedance is described. The method includes the detection of a system memory configuration within a memory channel coupled to a chipset driver/receiver. Once the system memory configuration is detected, a driver output impedance of the chipset driver is set according to the detected system memory configuration. As a result, by dynamically setting the driver output impedance according to the detected system memory configuration, voltage swings, as well as reflections, along the memory bus transmission lines are avoided. Consequently, the amount of time required for a signal to propagate along a memory bus from the chipset driver to the actual memory device is effectively reduced and thereby increases a total interconnect timing budget.

### FIELD OF THE INVENTION

The present invention relates generally to the field of chipset drivers. In particular, the present invention relates to an apparatus and method for a selectable RON driver impedance.

### BACKGROUND OF THE INVENTION

Input/output (I/O) circuits act as an interface between different logic functional units of an electrical system. These functional units may be implemented in separate integrated circuit dies (i.e., IC chips) of the system. In addition, the chips may be contained within separate IC packages that are soldered to a printed wiring board (i.e., PWB). As such, the chips communicate with each other over one or more conductive transmission lines. These transmission lines may be a parallel bus formed on a PVB, and they may be of the point-to-point or multi-drop variety. Alternatively, the transmission line may be a serial link, such as a coax cable.

In both cases, each chip has an I/O circuit that includes a driver (chipset driver) and a receiver (chipset receiver) for transmitting and detecting symbols. The chipset driver and receiver translate between on chip signaling and signaling that is suitable for high speed transmission (e.g., at several hundred megabits per second and higher) over a transmission line. Accordingly, when the transmission lines are implemented as a memory bus, a memory channel including one or more memory modules may receive, as well as transmit, data to the chipset driver and receiver of the I/O circuit.

Unfortunately, memory bus or I/O structures, such as described above, come in a multitude of load conditions, while I/O circuit (chipset) drivers operate under only one condition. For example, a memory channel coupled to the memory bus may include memory modules which include one or more sockets for loading a memory device. As such, based on the number of memory devices loaded within a respective memory module, the memory channel will exhibit a specific load condition. As a result, the load condition of the memory module will exacerbate non-idealities of the transmission line (memory bus) resulting in bit errors in the received signal.

Referring now to FIG. 1, FIG. 1 depicts a graph 100, illustrating transmitted waveforms resulting from a light load configuration 110 and a heavy load configuration 120. Accordingly, when the memory channel is in a lightly loaded configuration, signals transmitted along the memory bus will normally exhibit a higher voltage swing with much more reflections as they move along the transmission lines of the memory bus. Consequently, the voltage swings, as well as the reflections, on the transmission line often result in an adverse effect on the timing seen by the memory bus.

Referring now to FIGS. 2A and 2B, FIG. 2A illustrates a condition in which 82 picoseconds are lost as a result of going from a heavy load configuration (FIG. 2A) to a light load configuration (FIG. 2B) within the memory channel. In other words, signals transmitted along the memory bus will require an additional 82 picoseconds under the light load configuration in order to propagate to a destination memory device and achieve an acceptable level. Unfortunately, unless a transmitted signal achieves an acceptable level within an allotted interconnect timing budget, the destination memory device will be unable to properly determine transmitted signal patterns.

As a result, memory bus structures, as described above, utilize an interconnect timing budget in order to assure proper receipt of a signal transmitted by the chipset receiver to a destination device. As described herein, an interconnect timing budget refers to a predetermined period of time in which a signal transmitted by a chipset driver must propagate along the bus interconnect between the chipset and the memory module slot and along an interconnect within the memory module slot to the actual memory device and achieve an acceptable level once received at the memory module.

As such, referring again to FIGS. 2A and 2B, assuming a total interconnect timing budget of 400 picoseconds, the loss resulting from a light load configuration (82 picoseconds) equates to 20.5 percent of the total interconnect timing budget which is lost due to the loading effect. Therefore, there remains a need to overcome one or more of the limitations in the above-described, existing art.

### BRIEF DESCRIPTION OF THE DRAWINGS

The features, aspects, and advantages of the present invention will become more fully apparent from the following detailed description and appended claims when taken in conjunction with accompanying drawings in which:

FIG. 1 depicts a graph illustrating wave forms within a transmission line resulting from a lightly loaded system memory configuration and a heavily loaded system memory configuration.

FIGS. 2A and 2B depict graphs illustrating loss of a portion of an interconnect timing budget when going from a heavy load configuration to a light load configuration.

FIG. 3 depicts a block diagram illustrating a computer system capable of implementing the teachings of the present invention in accordance with an embodiment of the present invention.

FIG. 4 depicts a block diagram further illustrating the computer system as depicted in FIG. 3 in accordance with a further embodiment of the present invention.

FIGS. 5A-5C depict graphs illustrating a reduction in an interconnect timing budget resulting from utilizing the teachings of the present invention.

FIG. 6 depicts a block diagram further illustrating the computer system as depicted in FIG. 3 in accordance with an exemplary embodiment of the present invention.

FIG. 7 depicts a chart illustrating variations in an interconnect timing budget when skewing elements of the computer system, as depicted in FIG. 6, with either a light load system configuration or a heavy load system configuration in accordance with an exemplary embodiment of the present invention.

FIG. 8 depicts a block diagram illustrating an electronic system implementing the teachings of the present invention in accordance with a further embodiment of the present invention.

FIG. 9 depicts a flowchart illustrating a method for a selectable RON driver impedance in accordance with an embodiment of the present invention.

FIG. 10 depicts a flowchart illustrating an additional method for detecting a system memory configuration in accordance with an embodiment of the present invention.

FIG. 11 depicts a flowchart illustrating an additional method for setting a chipset driver output impedance in accordance with a further embodiment of the present invention.

FIG. 12 depicts a flowchart illustrating an additional method for setting a chipset driver output impedance in accordance with an exemplary embodiment of the present invention.

### DETAILED DESCRIPTION

A method and apparatus for a selectable RON driver impedance are described. The method includes the detection of a system memory configuration within a memory channel coupled to a chipset driver/receiver. Once the system memory configuration is detected, a driver output impedance of the chipset driver is set according to the detected system memory configuration. As a result, by dynamically setting the driver output impedance (RON) according to the detected system memory configuration, voltage swings, as well as reflections, along the memory bus transmission lines are avoided. Consequently, the amount of time required for a signal to propagate along a memory bus from the chipset driver to the actual memory device is effectively reduced and thereby increases a total interconnect timing budget.

In the following description, for the purposes of explanation, numerous specific details are set forth in order to provide a thorough understanding of the present invention. It will be apparent, however, to one skilled in the art that the present invention may be practiced without some of these specific details. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention. In other instances, well-known structures and devices are shown in block diagram form in order to avoid obscuring the details of the present invention.

In an embodiment, the methods of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product which may include a machine or computer-readable medium having stored thereon instructions which may be used to program a computer (or other electronic devices) to perform a process according to the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

System Architecture

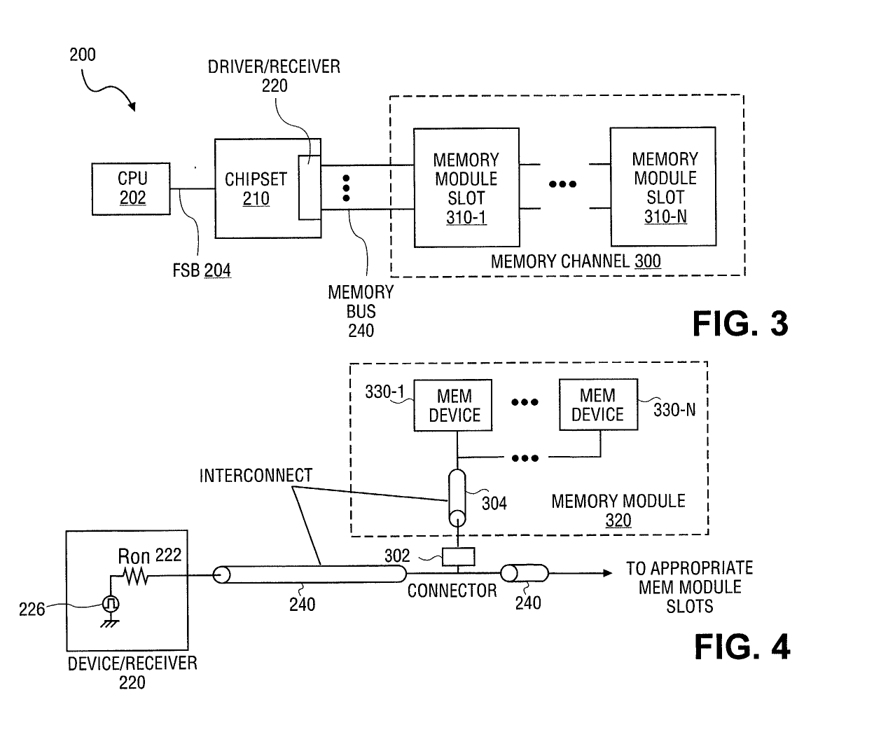

Referring now to FIG. 3, FIG. 3 depicts a block diagram illustrating a computer system 200, which may utilize the teachings of the present invention. Accordingly, the system 200 may incorporate a selectable output driver impedance (RON) in order to reduce reflections, interference and the like within transmission lines to a memory module. Accordingly, using a selectable RON driver impedance within the system 200 results in a reduction of a required interconnect timing budget in accordance with an embodiment of the present invention.

The computer system 200 includes a chipset 210, which may be coupled to one or more processors (CPU) 202 by, for example, a front side bus (FSB) 204. The chipset 210 includes a driver/receiver 220, which is coupled to a memory channel 300 via a memory bus 240. The memory channel 300 includes one or more memory module slots 310 (310-1, . . . , 310-N). Accordingly, depending on the system memory configuration of a computer system 200, the memory module add-in slots 310 may or may not be loaded with the memory device, such as for example, a dual inline memory module (DIMM) card. In addition, when the memory module add-in slot is loaded, the memory module contained therein may or may not include more than one memory device.

Referring to FIG. 4, FIG. 4 further illustrates the computer system 200 as depicted in FIG. 3. As depicted in FIG. 4, a memory module slot 310 of the computer system 200 is depicted with a memory module 320 load therein. The memory module 320 includes one or more memory devices 330 (330-1, . . . , 330-N). As illustrated, the computer system 200 couples the various loaded memory modules 330 to the chipset driver/receiver 220 via interconnect 240. The interconnect 240, or memory bus 240, refers to the actual wires that are on the printed circuit board (PCB) (not shown) that connect the chipset 210 to the memory module add-in slot 310.

Accordingly, the entire interconnect is comprised of interconnect 240 as well as the connection between the memory module connector 302 (interconnect 304), which connects each of the memory devices 330 within the memory module 320 to the connector 302. As such, within a computer system 200, as depicted in FIG. 4, an interconnect timing budget is required such that any signal transmitted from the driver 220 is able to propagate along interconnect 240, as well as interconnect 304, in order to reach the memory device 330 and achieve a recognizable signal level within a predetermined amount of time.

In one embodiment, the predetermined amount of time refers to one clock cycle or clock period. As such, unless the transmitted signal patterns from the driver 220 are able to propagate along the interconnect and reach the respective memory device within the memory module 320 within the allocated amount of time, bit errors will be encountered. In other words, unless the signals conform to the allocated interconnect budget, the received signal patterns are unrecognizable at their destination.

Unfortunately, voltage swings, as well as reflections, will occur along the interconnect transmission lines based on a load configuration of the memory channel 300. As such, when one or more of the memory module slots are empty, or when a memory module contains less memory devices than the memory module device capacity, the memory channel will generally find itself a light load configuration. Alternatively, when each memory module slot is loaded and each memory device within the memory module is loaded, the memory channel will suffer from a heavy load configuration.

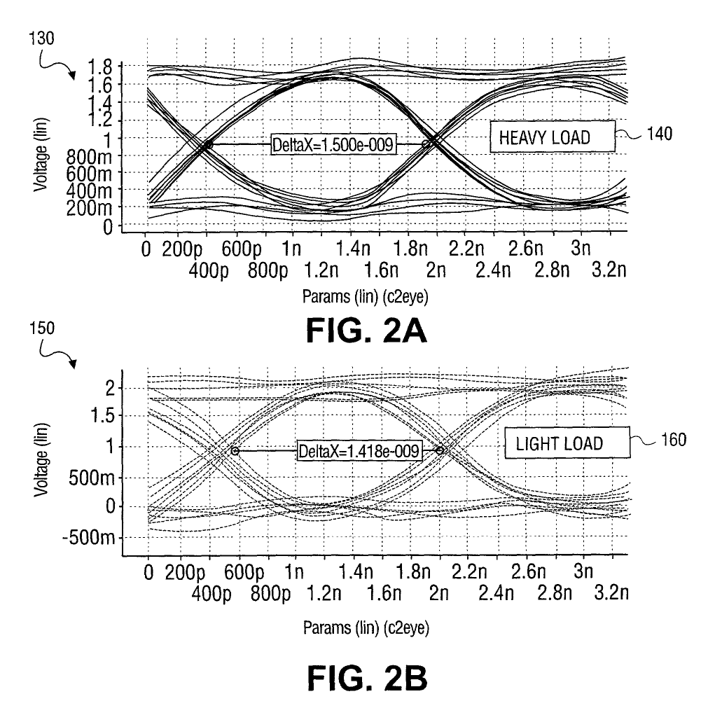

As illustrated in FIG. 2B, the light load configuration results in an 82 picosecond loss of the signal interconnect time period. For example, assuming a 266 MHz clock or 533 mega transfers, the clock cycle time, or clock period, equates to about 1.875 nanoseconds, from which an interconnect timing budget is taken. However, from the 1.875 nanosecond clock period, a chipset set-up time as well as a memory set-up time are deducted. Consequently, once these set-up times are deducted, a 0.400 nanosecond total interconnect timing budget is left. As such, deducting 82 picoseconds from the allocated timing budget lost due to a light load or a heavy load effect results in a 20.5 percent loss. As a result, additional clock speeds are clearly dependent on minimizing a required interconnect timing budget.

Referring again to FIG. 4, the driver/receiver 220 includes an output impedance (RON) 222. In the depicted embodiment, the chipset includes the capability to dynamically change the driver output impedance based on the detected system memory configuration. Accordingly, by setting the driver output impedance based on a detected memory configuration, voltage swings, as well as reflections, encountered on the memory bus 240 are eliminated. As a result, the interconnect time for proper signal propagation and detection is thereby reduced, which may eventually lead to increased clock speeds.

In one embodiment, detection of the system memory configuration may be performed during initial boot-up configuration of the computer system 200 within the system BIOS. In the embodiment described, at boot-up the chipset checks the memory configuration of the system. For example, assuming a desktop workstation, including two DIMM module add-in slots, if the chipset detects a light load configuration, the BIOS can dynamically change/set the RON of the driver 220 to a predetermined high impedance value. Alternatively, if a heavy load configuration is detected, a lower RON impedance may be set.

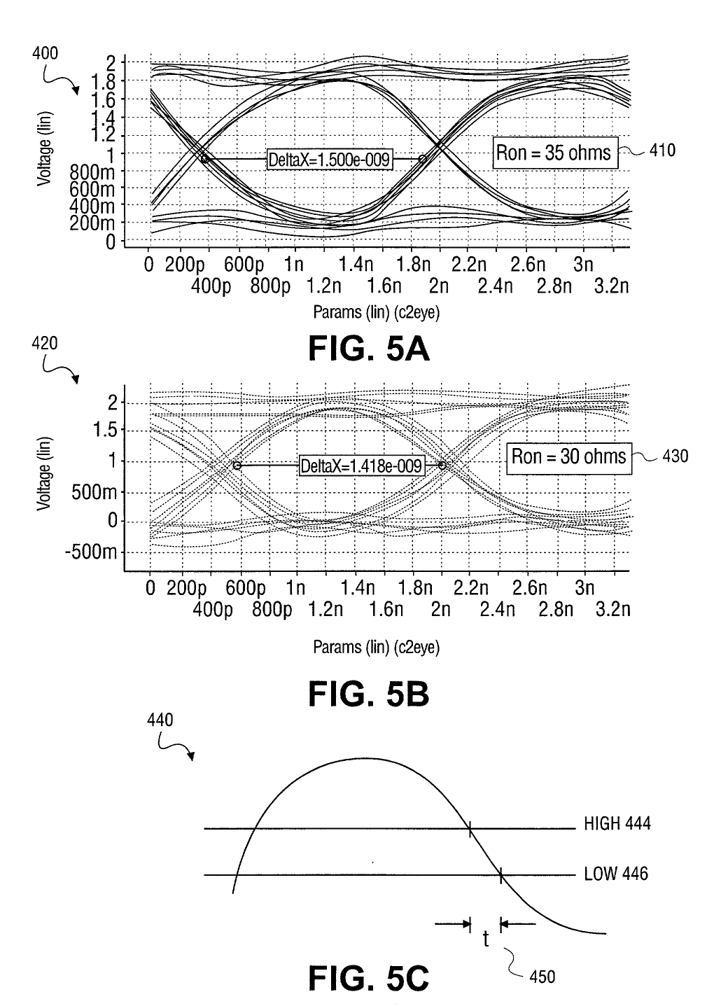

Referring now to FIGS. 5A-5C, FIGS. 5A-5C illustrate utilization of a high impedance value to minimize the amount of interconnect time lost due to a light load memory configuration. In other words, as illustrated in FIG. 5C, a waveform is recognized by comparing the waveform to a high threshold region and a low threshold region. Assuming binary level signaling, if the waveform is above the high threshold region when the system is clocked, the waveform is easily recognized as a high or value of “1”, while when the waveform is below the low threshold region, the waveform is correctly recognized as a 0 value.

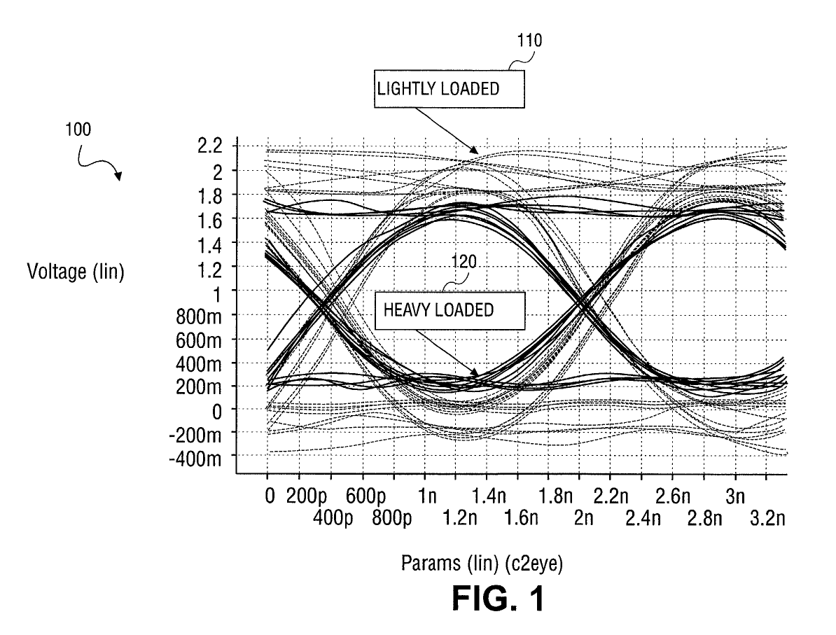

However, as illustrated in FIG. 1, reflections resulting from a lightly loaded configuration will tend to have a fringing effect, or skew, on the transmitted waveform, which pushes out the waveform and thereby increases the amount of time it takes the waveform to transition between the high threshold region and the low threshold region. Consequently, unless this time is minimized, the interconnect timing budget is drastically effected. Accordingly, in order to effectively increase the total interconnect timing budget, the amount of time which it takes a waveform to transition between the high threshold region and a low threshold region is minimized, as depicted in FIG. 5A.

FIG. 5A illustrates the setting of the driver output impedance to a value of 35 ohms (high impedance value) in response to detection of a light load system memory configuration. When compared to the waveform depicted in FIG. 5B, the increase of the RON value to 35 ohms for the lightly loaded configuration results in an improvement in the bus timings of 95 picoseconds (1.513-1.418). As such, by comparing FIGS. 5A and 5B, a total interconnect timing budget increase of 25 percent is realized by dynamically changing the driver output impedance. Consequently, by minimizing the amount of time it takes a signal to transition through the region, a 23.7 percent increase in the interconnect timing budget for a lightly loaded system memory configuration is realized.

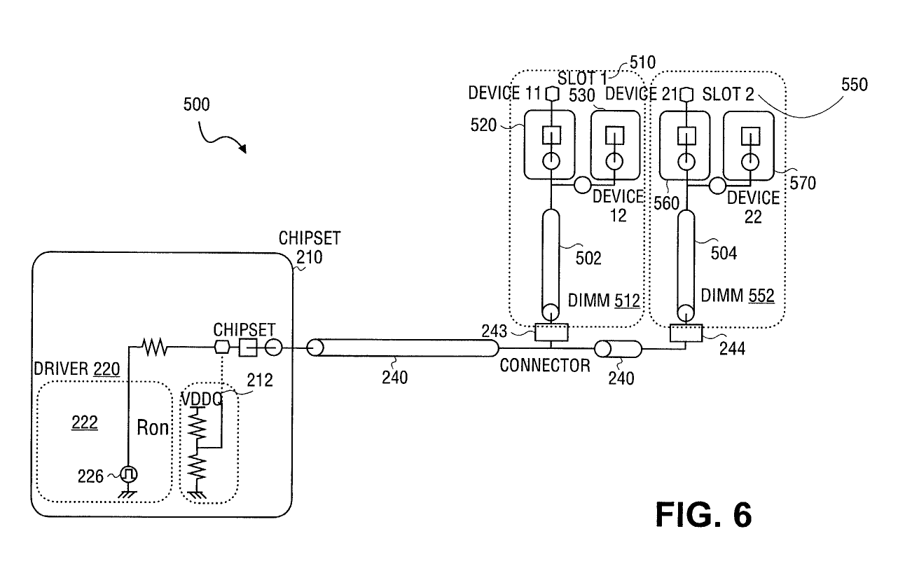

Referring now to FIG. 6, FIG. 6 depicts a computer system 500, for example as depicted in FIGS. 2 and 3, which utilizes two DIMM add-in slots (510 and 550). As such, during, for example, system initialization, the chipset 210 may detect whether either of the DIMM add-in slots (510 and 550) are empty and whether each memory device (520/530 and 560/570) within each DIMM module (512 and 552) is loaded. As a result, when either of the DIMM add-in slots (510/550) are empty or when either of the memory devices within the DIMM modules are unloaded, the system 500 may detect a light load configuration. Accordingly, the chipset 210 dynamically sets the driver output impedance (RON) to a predetermined high impedance value.

In one embodiment, the high impedance value of the computer system 500, is, for example 35 ohms, while the low impedance value is 30 ohms. As such, if the chipset 210 detects a heavy load system memory configuration, the driver output impedance (RON) may be set to a low impedance value of, for example, 30 ohms. In the embodiment described, the heavy load configuration indicates a system memory configuration in which each of the DIMM add-in slots (510/550) is populated and each memory device within each DIMM is loaded. As such, by dynamically raising the value of the driver output impedance (RON) in response to detection of the lightly loaded configuration, an increase in the timing margin for the memory bus is realized.

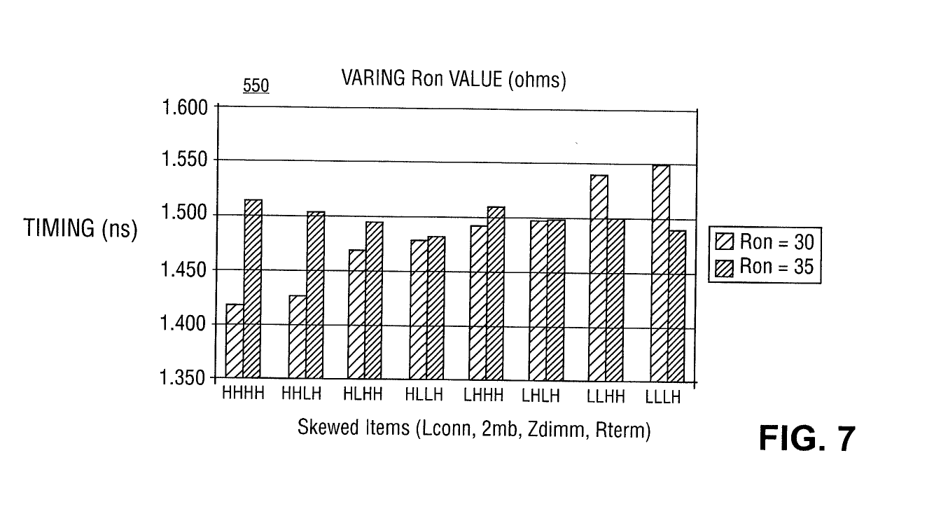

Referring now to FIG. 7, FIG. 7 illustrates a chart wherein connector parasitics board impedance and mismatches with the termination resistor in the computer system 500, as depicted in FIG. 6, are intentionally skewed. As such, in the embodiment described, the connector inductance (LCONN), the motherboard impedance (ZMB), the driver impedance (ZDIMM) and the termination resistance (RTERM) are simulated as either a high value or a low value, as indicated by either an H or an L. In addition, the bars of the graph illustrate the driver output resistance as set to either 30 ohms (low impedance value) or 35 ohms (high impedance value). Accordingly, examination of FIG. 7 illustrates that by dynamically setting the driver output impedance and varying the previously described values, a memory bus timing margin is increased from 1.42 nanoseconds to 1.84 nanoseconds with overall improvement of approximately 15 percent across all system corners.

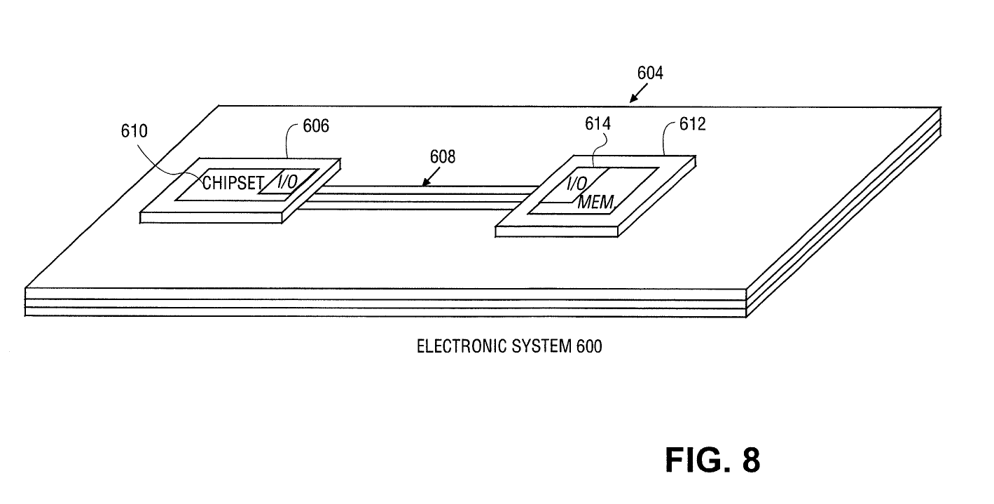

Turning now to FIG. 8, what is shown is a block diagram of an embodiment of an electronic system 600 in which an input/output section utilizes a selectable RON driver output impedance, as described above. The system has a multilayer printed wiring board 604 on which a parallel bus 608 is formed. The bus 608 may be of the point-to-point variety, or multi-drop buses, such as those used in a main memory. An integrated circuit (IC) chip packet 606 is operatively installed on the board to communicate using the parallel bus 608.

In one embodiment, installation of the package 606 may be done by a service mount technique or via a connector or socket. The package includes an IC chip (chipset) 610 that includes a logic function section and an I/O section (driver/receiver) as an interface between the logic function section and the bus 608. The logic function may be one of the following well-known devices: a microprocessor, a memory controller, a bus bridge, or the like. Alternatively, other devices that can be implemented in the logic function section of an IC chip may be used.

In the embodiment described, the I/O section includes a chipset driver which utilizes a selectable RON driver impedance, which is set according to a detected system memory configuration as described above. A second IC chip package 612 is also installed on the board 604 to communicate with the first package 606 via the bus 608. The second IC package 712 also includes a chip 614 having an I/O section in which a chipset receiver is provided to interface the bus 608 and its own function logic section (here shown as a memory controller).

According to an embodiment, the I/O interfaces of the two chips 610 and 612 communicate with each other bi-directionally, that is using the same conductive lines of the bus for both transmitting and receiving data. Thus, in such an embodiment, drivers are provided in both IC chips that are connected to the same conductive lines of the bus 608. Other system applications of the selectable driver output impedance are possible, including for example, virtually any chipset driver which is limited by an interconnect timing budget in which signals must propagate and reach a destination at a desired signal level. Procedural methods for implementing the teachings of the present invention are now described.

Operation

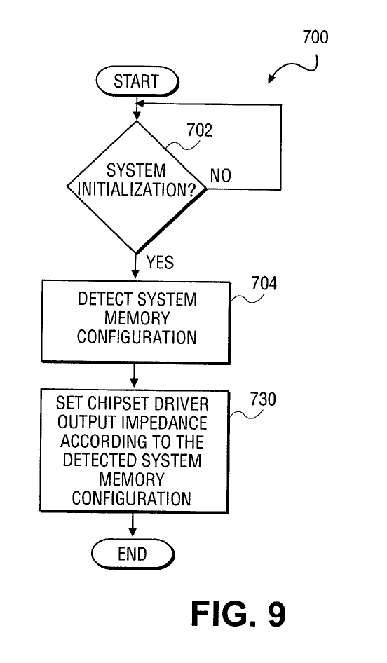

Referring now to FIG. 9, FIG. 9 depicts a flowchart illustrating a method 700 for detecting a system memory configuration and setting a driver output impedance in response to the detected system memory configuration. The method 700 is performed, for example, within the computer systems as depicted in FIGS. 3, 4, 6 and 8. At process block 702, it is determined whether system initialization is detected. As such, in the embodiment described, setting of the driver output impedance occurs during system initialization, for example, during system BIOS at system start-up. However, those skilled in the art will recognize that setting of the driver output impedance may occur during system run time, shut-down or start-up, as desired.

Once system initialization is detected, process block 704 is performed. At process block 704, the system memory configuration of the computer system is detected. As such, in the embodiments described, depending on the number of the memory module add-in slots, as well as the various capabilities of the memory modules, one or more (predetermined value(s)) counts may be determined in order to define the various system memory configurations. As such, utilizing the skills known in the art, the various system memory configurations may be determined as heavy loaded system memory configurations, light loaded configurations, medium loaded configurations or variations therebetween.

Accordingly, these determinations, the various driver output impedances may be determined using various trial and error techniques, with the results being stored in a look-up table which may be queried based on the detected system memory configuration, including a load configuration as well as the memory capacity. Once the system memory configuration is detected, process block 730 is performed. At process block 730, the chipset driver output impedance is set according to the detected system memory configuration, which will be described in further detail below.

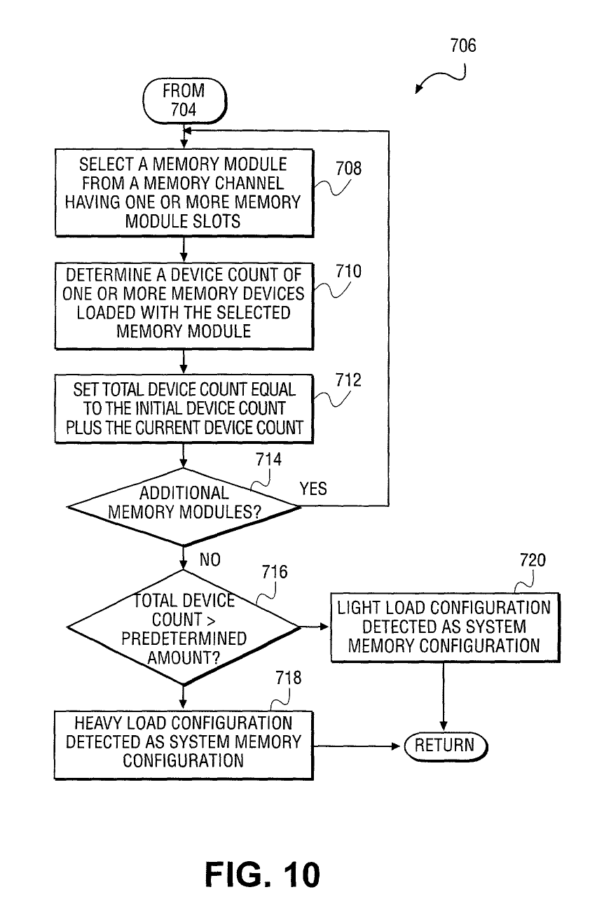

Referring now to FIG. 10, FIG. 10 depicts an additional method 706 for detecting the system memory configuration of process block 704, as depicted in FIG. 9. At process block 708, a memory module is selected from a memory channel having one or more memory module add-in slots. At process block 710, a device count of one or more memory devices loaded within the selected memory module is determined. For example, in the embodiment described in FIG. 6, the chipset 210 may query a serial presence detect (SBD register) of a DIMM card (512/552) in order to determine whether both sides of the DIMM add-in card are populated. As known to those skilled in the art, one rank includes or describes population of one side of the DIMM card, while rank two indicates population of both sides of a DIMM card.

Once the device count is detected, process block 712 is performed. At process block 712, a total device count is set to the total device count plus the current device count. As such, process blocks 708-712 are repeated for each memory module of the memory channel. Once completed, at process block 716, the total device count is compared against a predetermined amount. As described above, the predetermined amount is determined using the skill in the art by analyzing various load configurations and system memory configurations in comparison to various driver output impedances in order to determine ideal process conditions.

For example, referring to the computer system 500 as depicted in FIG. 6, a light load configuration would equate to a device count which is less than, for example 3, while a heavy load condition would equate to a device count or predetermined amount of 4, while a medium load condition might equate to a device count of 3. Once compared, when a total device count is greater than the predetermined amount, a heavy load configuration is detected as the system memory configuration at process block 718. Otherwise, at process block 720, a light load configuration is detected as the system memory configuration. Once detected, control flow returns to process block 704 of FIG. 9.

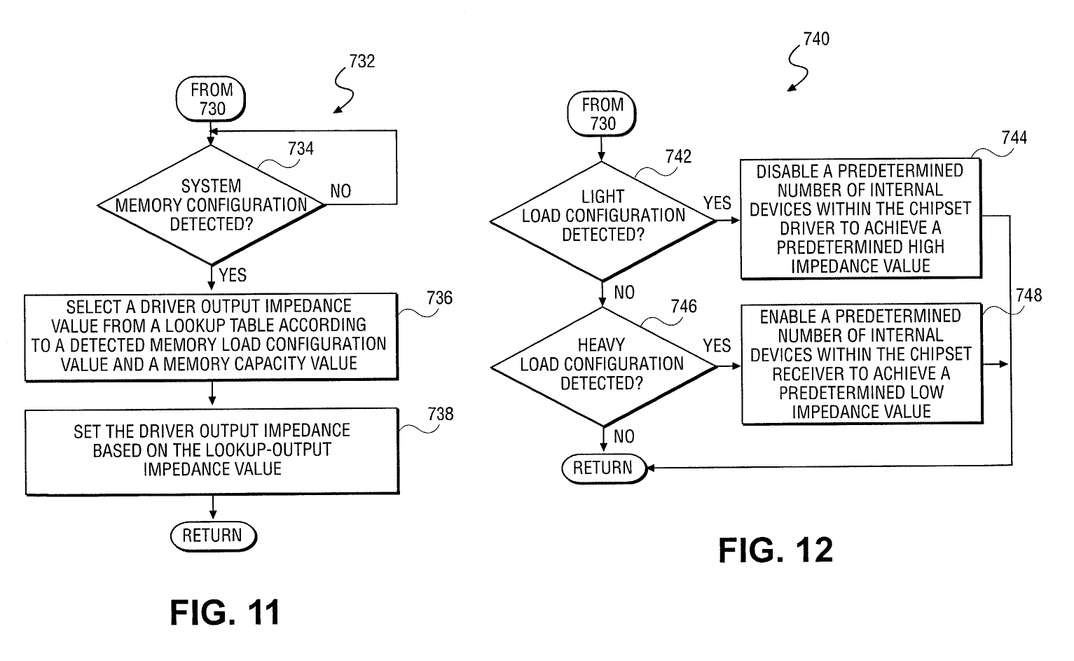

Referring now to FIG. 11, FIG. 11 depicts an additional method 732 for setting the driver output impedance of process block 730 as depicted in FIG. 9. At process block 734, it is determined whether the system memory configuration has been detected. In one embodiment, the system memory configuration is detected once a detected memory load configuration value and a memory capacity value are received. Once detected, at process block 736, a driver output impedance value is selected from a look-up table according to the detected memory load configuration value and the detected memory capacity value. Once the output impedance value is looked up, at process block 738, the driver output impedance is set based on the look-up output impedance value. Although described with reference to a look-up table, the various calculated values for the ideal process conditions may be stored in any number of devices, such as registers, cache memory or the like, depending on the desired system implementation.

Finally, referring to FIG. 12, FIG. 12 depicts an additional method for setting the driver output impedance at process block 730, as depicted in FIG. 9. At process block 742, it is determined whether a light load configuration is detected. When a light load configuration is detected, process block 744 is performed. At process block 744, a predetermined number of internal devices within the chipset driver are disabled to achieve a predetermined high impedance value. As known to those skilled in the art, the chipset driver may be implemented using a plurality of various internal devices for driving signals along the memory bus, such as for example, transistors.

Accordingly, by disabling a predetermined number of the internal devices within the chipset driver, the output impedance value is thereby increased in order to achieve a predetermined high impedance value, such as for example, 35 ohms. Otherwise, at process block 746, it is determined whether a heavy load configuration is detected. When such is detected, at process block 748, a predetermined number of internal devices within the chipset driver are enabled to achieve a predetermined low impedance value. As such, by increasing the number of internal drivers within the chipset driver, the impedance of a driver is thereby decreased in order to avoid voltage swings as well as reflections, which result from a heavy load effect.

Therefore, utilizing the teachings of the present invention, the driver output impedance may be dynamically set according to a detected system memory configuration. In doing so, voltage swings, as well as reflections, which effect transmitted signals along a transmission line may be avoided. As illustrated in FIG. 1, such reflections will cause transmitted signals to suffer fringing effect or skew, which results in pushing out of the transmitted waveforms, which will increase the amount of time that the waveform requires in order to transition between a high threshold region and a low threshold region.

As such, unless the amount of time required to transition between the high threshold and the low threshold region is reduced, increased clock speeds may result in bit errors due to the fact that the signals cannot propagate to their desired destination within the allotted time. However, by decreasing the transition time, delay to the effective interconnect timing budget are avoided, resulting in a decreased interconnect time, which may allow future designs to incorporate increased clock speeds.

Alternate Embodiments

Several aspects of one implementation of the memory bus structure for providing a selectable RON driver impedance have been described. However, various implementations of the selectable RON driver impedance provide numerous features including, complementing, supplementing, and/or replacing the features described above. Features can be implemented as part of the memory bus structure or as part of the various chipset drivers in different implementations. In addition, the foregoing description, for purposes of explanation, used specific nomenclature to provide a thorough understanding of the invention. However, it will be apparent to one skilled in the art that the specific details are not required in order to practice the invention.

In addition, although an embodiment described herein is directed to a selectable RON driver impedance, it will be appreciated by those skilled in the art that the teaching of the present invention can be applied to other systems. In fact, systems for dynamically altering driver impedance are within the teachings of the present invention, without departing from the scope and spirit of the present invention. The embodiments described above were chosen and described in order to best explain the principles of the invention and its practical applications. These embodiment were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the present invention to the full extent indicated by the broad general meaning of the terms in which the appended claims are expressed.

The present invention provides many advantages over known techniques. The present invention includes the ability. Accordingly, a driver output impedance may be dynamically set according to a detected system memory configuration. In doing so, voltage swings, as well as reflections, which effect transmitted signals along a transmission line are avoided. In addition, the present invention reduces the amount of time required to transition between a high threshold and a low threshold region. As a result, increased clock speeds will not result in bit errors due to the fact that the signals cannot propagate to their desired destination within the allotted time. Therefore, by decreasing the transition time, delay to the effective interconnect timing budget are avoided, resulting in a decreased interconnect time, which will allow future designs to incorporate increased clock speeds.

Having disclosed exemplary embodiments, modifications and variations may be made to the disclosed embodiments while remaining within the scope of the invention as defined by the following claims.

What is claimed is:

1. A method comprising:
detecting a system memory configuration; and
setting a chipset driver output impedance according to the detected system memory configuration, thereby increasing an interconnect timing budget.

2. The method of claim 1, wherein detecting the system memory configuration further comprises:
selecting a memory module from a memory channel having one or more memory module slots;
determining, for the selected memory module, a device count of one or more memory devices loaded within the selected memory module;
repeating the selecting and determining for each memory module of the memory channel such that a total device count equals the sum of each determined socket device;
when the total device count exceeds a predetermined number, detecting a heavy load configuration as the system memory configuration; and
otherwise detecting a light load configuration as the system memory configuration.

3. The method of claim 2, wherein determining the device count further comprises querying a configuration register of the selected memory module to determine the device count of each corresponding device that is loaded with the selected memory module.

4. The method of claim 2, wherein setting the driver output resistance further comprises:
when a light load configuration is detected as the system memory configuration, setting the driver output impedance to a predetermined high impedance value; and
when a heavy load configuration is detected as the system memory configuration, setting the driver output impedance to a predetermined low impedance value.

5. The method of claim 4, wherein setting the driver output impedance to the predetermined high impedance value further comprises:
disabling a predetermined number of internal devices within the chipset driver to thereby increase the driver output impedance by a predetermined amount to achieve the predetermined high impedance value.

6. The method of claim 4, wherein setting the driver output impedance to the predetermined low impedance value further comprises:
enabling the number of internal devices within the chipset driver such that the driver output impedance of the chipset driver is decreased by a predetermined amount to achieve the predetermined low impedance value.

7. The method of claim 1, wherein setting the driver output resistance further comprises:
receiving a detected system memory configuration, including a memory load configuration value and a memory capacity value;
selecting a driver output impedance value within a lookup table according to the received memory load condition value and the received memory capacity value; and
setting the driver output impedance based on the looked up driver output impedance value.

8. The method of claim 1, wherein determining the system memory configuration and setting the driver output impedance are performed during system BIOS.

9. The method of claim 1, wherein the detected system memory configuration is one of a light load configuration and a heavy load configuration.

10. The method of claim 1, wherein the driver output impedance is set as one of a high impedance value and a low impedance value according to the detected system memory configuration.

11. A computer readable storage medium including program instructions that direct a computer to function in a specified manner when executed by a processor, the program instructions comprising:
detecting a system memory configuration; and
setting a chipset driver output impedance according to the detected system memory configuration, thereby increasing an interconnect timing budget.

12. The computer readable storage medium of claim 11, wherein detecting the system memory configuration further comprises:
selecting a memory module from a memory channel having one or more memory module sockets;
determining, for the selected memory module, a device count of one or more memory device that are loaded with the selected memory module;
repeating the selecting and determining for each memory module of the memory channel such that a total device count equals the sum of each determined device count; and
when the total device count exceeds a predetermined number, detecting a heavy load configuration as the system memory configuration; and
otherwise detecting a light load configuration as the system memory configuration.

13. The computer readable storage medium of claim 12, wherein determining the device count further comprises querying a configuration register of the selected memory module to determine the device count of each corresponding memory device that is loaded with the selected memory module.

14. The computer readable storage medium of claim 12, wherein setting the driver output resistance further comprises:
when a light load configuration is detected as the system memory configuration, setting the driver output impedance to a predetermined high impedance value; and
when a heavy load configuration is detected as the system memory configuration, setting the driver output impedance to a predetermined low impedance value.

15. The computer readable storage medium of claim 14, wherein setting the driver output resistance to the predetermined high impedance value further comprises:
removing a predetermined number of internal devices within the chipset driver to thereby increase the driver output impedance by a predetermined amount to achieve the predetermined high impedance value.

16. The computer readable storage medium of claim 14, wherein setting the driver output impedance to the predetermined low impedance value further comprises:
increasing the number of internal devices within the chipset driver such that the driver output impedance of the chipset driver is decreased by a predetermined amount to achieve the low impedance value.

17. The computer readable storage medium of claim 11, wherein setting the chipset driver output impedance further comprises:
receiving a detected system memory configuration, including a memory load configuration value and a memory capacity value;
selecting a driver output impedance value within a lookup table according to the received memory load condition value and the received memory capacity value; and
setting the chipset driver output impedance based on the looked up driver output resistance value.

18. The computer readable storage medium of claim 11, wherein determining the system memory configuration and setting the driver output impedance are performed during system BIOS.

19. The computer readable storage medium of claim 11, wherein the detected system memory configuration is one of a light load configuration and a heavy load configuration.

20. The computer readable storage medium of claim 11, wherein the driver output impedance is set as one of high impedance value and a low impedance value according to the detected system memory configuration.

21. An apparatus comprising:
a processor having circuitry to execute instructions;
a chipset driver coupled to the processor;
a memory channel coupled to the chipset driver, the memory channel including one or more memory module slot for loading a memory module, including one or more memory devices; and
a storage device coupled to the processor, having sequences of instructions stored therein, which when executed by the processor cause the processor to:
detect a system memory configuration of the memory channel, and
set a driver output impedance according to the detected system memory configuration, thereby increasing an interconnect timing budget.

22. The apparatus of claim 21, wherein the instruction to detect the system memory configuration further causes the processor to:
select a memory module loaded within a memory module slot of the memory channel;
determine for the selected memory module, a device count of the one or more memory devices that are loaded with the selected memory module;
repeat the selecting and determining for each memory module loaded within a memory module slot of the memory channel, such that a total device count equals the sum of each determined device count; and
when the total device count exceeds a predetermined number, detect a heavy load configuration as the system memory configuration and otherwise detects a light load configuration as the system memory configuration.

23. The apparatus of claim 21, wherein the instruction to set the chipset driver output resistance further causes the processor to:
receive a detected system memory configuration, including a memory load configuration value and a memory capacity value;
select a driver output impedance value within a lookup table according to the received memory load condition value and the received memory capacity value; and
set the driver output impedance based on the looked up driver output impedance value.

24. An electronic system comprising:
a printed wiring board on which a parallel bus is formed; and
an integrated circuit (IC) chip package being operatively installed on the board to communicate using the parallel bus, the package having an IC chip that includes a logic function section and an I/O section as an interface between the logic function section and the bus, the I/O section having a chipset driver for communicating with a memory channel via the parallel bus, the memory channel including one or more memory module slots for loading memory modules including one or more memory devices, wherein the logic function section detects a system memory configuration and sets a driver output impedance of the chipset driver according to the detected system memory configuration.

25. The electronic system of claim 24, wherein the logic function section is a microprocessor.

26. The electronic system of claim 24, wherein the logic function section is a memory controller.

27. The electronic system of claim 24, wherein the logic function section is a bus bridge.
